(19) United States
(12) Patent Application Publication
(10) Pub. No.: US 2022/0350671 A1
(43) Pub. Date: Nov. 3, 2022

(54) Flexible Computation Capacity Orchestration

(71) Applicant: AT&T Intellectual Property I, L.P., Atlanta, GA (US)

(72) Inventors: Luis Albisu, Woodbridge, VA (US); Daniel Solero, Rockwall, TX (US); Imre Solymosi, Dallas, TX (US)

(73) Assignee: AT&T Intellectual Property I, L.P., Atlanta, GA (US)

(21) Appl. No.: 17/243,794

(22) Filed: Apr. 29, 2021

(51) Int. Cl. G06F 9/50

(52) U.S. Cl. CPC G06F 9/5072

(57) ABSTRACT

Flexible computation capacity orchestration can include obtaining, at a computer, operational data from an edge device that can communicate with the computer via a network. The operational data can include utilization data that can define a resource utilization of the edge device. If a determination is made that the resource utilization of the edge device satisfies the upper utilization limit, a command can be issued to create a device group that comprises the edge device and a further edge device. Operational data can be obtained from the edge device and the further edge device, the operational data defining a further utilization of the edge device and a utilization of the further edge device. If a determination is made that the further utilization is below the lower utilization limit, a further command to end the device group can be issued.

### BACKGROUND

The proliferation of computing capabilities has resulted in everyday objects often including computing capabilities. For example, some refrigerators, washing machines, light switches, doorbells, and/or other devices available today may include computers and/or computing capabilities. These devices, however, may have limited processing power relative to some computers. This limited processing power can, in some instances, affect the relative speed and efficiency of these devices.

### SUMMARY

The present disclosure is directed to flexible computation capacity orchestration. Two or more edge devices such as laptops, routers, gateways, cloud computing devices, Internet-of-things devices, smartphones, or the like can communicate with a network. One or more of the edge devices can execute respective instances of a flexible computation capacity orchestration application. The flexible computation capacity orchestration application can monitor performance of the respective edge device to detect computations that can/should be offloaded to other edge devices and/or to determine utilizations of the edge device. According to various embodiments, the flexible computation capacity orchestration application can be configured to generate one or more instances of operational data. The operational data can include security data that can define security capabilities of the edge device; utilization data that can define processor, memory, and/or other resource utilization of the edge device; network data that can define network abilities and/or utilization of the edge device; and/or other data that can identify the edge device and/or provide other information associated with the edge device such as addresses, or the like. The edge device can provide the operational data to a flexible computation capacity orchestration service, which in some instances can be hosted and/or executed by a server computer.

The flexible computation capacity orchestration service can be configured to analyze the operational data to determine if one or more computations should be offloaded from the edge device and, if so, to which other edge device(s). In some embodiments, the flexible computation capacity orchestration service can identify and/or determine the edge device(s) that are to perform the computations based on operational data associated with the other edge devices. As noted above, the operational data can define security abilities and/or capabilities associated with the edge devices; processor, memory, and/or other resource utilizations associated with the edge devices; network utilizations associated with the edge devices; other information associated with the edge devices; and the like. It should be understood that the utilization data of the operational data can define a utilization of a networking device of the edge device, while the network data can define available network resources (e.g., network bandwidth, etc.) for the edge device. It should be understood that this example is illustrative, and therefore should not be construed as being limiting in any way.

Based on these and/or other considerations, the flexible computation capacity orchestration service can determine if computations should be offloaded from the edge device to other edge devices. In various embodiments, this offloading can be accomplished in embodiments of the concepts and technologies disclosed herein by creating a device group that can share computational resources as illustrated and described herein. Thus, the flexible computation capacity orchestration service can identify the edge devices that should be added to the device group to share computational resources, an identification that can be based on utilizations, security capabilities, and/or other aspects of the edge devices. The flexible computation capacity orchestration service can be configured to generate one or more commands for effecting the creation of the device group and/or the sharing of data among the edge devices in the device group. It should be understood that this example is illustrative, and therefore should not be construed as being limiting in any way.

The edge devices in the device group can share data for computations with each other and generate, by performing computations on the data for computations, computed data, which can be returned to the edge device that originally offloaded computations to the other edge devices. When utilizations of the edge devices drop below defined levels, or when security requirements can no longer be complied with, the flexible computation capacity orchestration service and/or the flexible computation capacity orchestration application can be configured to cause use of the device group and/or to issue commands for causing and/or effecting the cessation of use of the device group. As such, computations can be offloaded from one edge device to other edge devices for a limited time, and members of a device group can change from time to time.

According to one aspect of the concepts and technologies disclosed herein, a system is disclosed. The system can include a processor and a memory. The memory can store computer-executable instructions that, when executed by the processor, cause the processor to perform operations. The operations can include obtaining, at a computer, operational data from an edge device. The edge device can communicate with the computer via a network. The operational data can include utilization data that can define a resource utilization of the edge device. The operations further can include determining if the resource utilization of the edge device satisfies an upper utilization limit, if a determination is made that the resource utilization of the edge device satisfies the upper utilization limit, issuing a command to create a device group that includes the edge device and a further edge device, obtaining, from the edge device and the further edge device, further operational data that can define a further utilization of the edge device and a utilization of the further edge device, determining if the further utilization is below a lower utilization limit, and if a determination is made that the further utilization is below the lower utilization limit, issuing a further command to end the device group.

In some embodiments, the resource utilization of the edge device can include a processor utilization of the edge device. In some embodiments, the resource utilization of the edge device can satisfy the upper utilization limit by exceeding the upper utilization limit. In some embodiments, the computer-executable instructions, when executed by the processor, can cause the processor to perform operations further including identifying a pool of candidate edge devices for the device group; and if a determination is made that a candidate edge device should be added to the device group, instructing the candidate edge device to be added to the device group. In some embodiments, the determination is made that the candidate edge device should be added to the device group by determining a security requirement for the device group and determining, based on the operational data, that the candidate edge device can satisfy the security requirement. In some embodiments, identifying the pool of candidate edge devices can include obtaining opt-ins from the pool of candidate edge devices.

In some embodiments, the computer-executable instructions, when executed by the processor, can cause the processor to perform operations further including if a determination is made that the candidate edge device should not be added to the device group, removing the candidate edge device from the pool of candidate edge devices, wherein the determination is made that the candidate edge device should not be added to the device group based on another utilization of the candidate edge device. In some embodiments, the computer-executable instructions, when executed by the processor, can cause the processor to perform operations further including if a determination is made that the candidate edge device should not be added to the device group, removing the candidate edge device from the pool of candidate edge devices. The determination can be made that the candidate edge device should not be added to the device group based on a security capability of the candidate edge device.

According to another aspect of the concepts and technologies disclosed herein, a method is disclosed. The method can include obtaining, at a computer including a processor, operational data from an edge device. The edge device can communicate with the computer via a network. The operational data can include utilization data that can define a resource utilization of the edge device. The method further can include determining, by the processor, if the resource utilization of the edge device satisfies an upper utilization limit; if a determination is made that the resource utilization of the edge device satisfies the upper utilization limit, issuing, by the processor, a command to create a device group that includes the edge device and a further edge device; obtaining, by the processor and from the edge device and the further edge device, further operational data that can define a further utilization of the edge device and a utilization of the further edge device; determining, by the processor, if the further utilization is below a lower utilization limit; and if a determination is made that the further utilization is below the lower utilization limit, issuing, by the processor, a further command to end the device group.

In some embodiments, the method further can include identifying a pool of candidate edge devices for the device group; and if a determination is made that a candidate edge device should be added to the device group, instructing the candidate edge device to be added to the device group. In some embodiments, the determination can be made that the candidate edge device should be added to the device group by determining a security requirement for the device group and determining, based on the operational data, that the candidate edge device can satisfy the security requirement. In some embodiments, identifying the pool of candidate edge devices can include obtaining opt-ins from the pool of candidate edge devices. In some embodiments, the method further can include if a determination is made that the candidate edge device should not be added to the device group, removing the candidate edge device from the pool of candidate edge devices. The determination can be made that the candidate edge device should not be added to the device group based on another utilization of the candidate edge device.

According to yet another aspect of the concepts and technologies disclosed herein, a computer storage medium is disclosed. The computer storage medium can store computer-executable instructions that, when executed by a processor, cause the processor to perform operations. The operations can include obtaining, at a computer, operational data from an edge device. The edge device can communicate with the computer via a network. The operational data can include utilization data that can define a resource utilization of the edge device. The operations further can include determining if the resource utilization of the edge device satisfies an upper utilization limit, if a determination is made that the resource utilization of the edge device satisfies the upper utilization limit, issuing a command to create a device group that includes the edge device and a further edge device, obtaining, from the edge device and the further edge device, further operational data that can define a further utilization of the edge device and a utilization of the further edge device, determining if the further utilization is below a lower utilization limit, and if a determination is made that the further utilization is below the lower utilization limit, issuing a further command to end the device group.

In some embodiments, the resource utilization of the edge device can include a processor utilization of the edge device. In some embodiments, the resource utilization of the edge device can satisfy the upper utilization limit by exceeding the upper utilization limit. In some embodiments, the computer-executable instructions, when executed by the processor, can cause the processor to perform operations further including identifying a pool of candidate edge devices for the device group; and if a determination is made that a candidate edge device should be added to the device group, instructing the candidate edge device to be added to the device group.

In some embodiments, the determination is made that the candidate edge device should be added to the device group by determining a security requirement for the device group and determining, based on the operational data, that the candidate edge device can satisfy the security requirement. In some embodiments, identifying the pool of candidate edge devices can include obtaining opt-ins from the pool of candidate edge devices. In some embodiments, the computer-executable instructions, when executed by the processor, can cause the processor to perform operations further including if a determination is made that the candidate edge device should not be added to the device group, removing the candidate edge device from the pool of candidate edge devices. The determination can be made that the candidate edge device should not be added to the device group based on another utilization of the candidate edge device.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIGS. 1A-1B are system diagrams illustrating an illustrative operating environment for various embodiments of the concepts and technologies described herein.

FIG. 2 is a flow diagram showing aspects of a method for orchestrating a device group to provide flexible computation capacity, according to an illustrative embodiment of the concepts and technologies described herein.

FIG. 3 is a flow diagram showing aspects of a method for joining and leaving a device group that provides flexible computation capacity, according to an illustrative embodiment of the concepts and technologies described herein.

FIG. 4 is a flow diagram showing aspects of a method for identifying devices for a device group to provide flexible computation capacity, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide flexible computation capacity orchestration, according to some illustrative embodiments of the concepts and technologies described herein.

FIG. 7 is a block diagram illustrating an example mobile device configured to act as an edge device and/or to interact with a flexible computation capacity orchestration service, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to flexible computation capacity orchestration. Two or more edge devices such as laptops, routers, gateways, Internet-of-things devices, smartphones, or the like can communicate with a network. One or more of the edge devices can execute respective instances of a flexible computation capacity orchestration application. The flexible computation capacity orchestration application can monitor performance of the respective edge device to detect computations that can/should be offloaded to other edge devices and/or to determine utilizations of the edge device. According to various embodiments, the flexible computation capacity orchestration application can be configured to generate one or more instances of operational data. The operational data can include security data that can define security capabilities of the edge device; utilization data that can define processor, memory, and/or other resource utilization of the edge device; network data that can define network abilities and/or utilization of the edge device; and/or other data that can identify the edge device and/or provide other information associated with the edge device such as addresses, or the like. The edge device can provide the operational data to a flexible computation capacity orchestration service, which in some instances can be hosted and/or executed by a server computer.

The flexible computation capacity orchestration service can be configured to analyze the operational data to determine if one or more computations should be offloaded from the edge device and, if so, to which other edge device(s). In some embodiments, the flexible computation capacity orchestration service can identify and/or determine the edge device(s) that are to perform the computations based on operational data associated with the other edge devices. As noted above, the operational data can define security abilities and/or capabilities associated with the edge devices; processor, memory, and/or other resource utilizations associated with the edge devices; network utilizations associated with the edge devices; other information associated with the edge devices; and the like. It should be understood that the utilization data of the operational data can define a utilization of a networking device of the edge device, while the network data can define available network resources (e.g., network bandwidth, etc.) for the edge device. It should be understood that this example is illustrative, and therefore should not be construed as being limiting in any way.

Based on these and/or other considerations, the flexible computation capacity orchestration service can determine if computations should be offloaded from the edge device to other edge devices. In various embodiments, this offloading can be accomplished in embodiments of the concepts and technologies disclosed herein by creating a device group that can share computational resources as illustrated and described herein. Thus, the flexible computation capacity orchestration service can identify the edge devices that should be added to the device group to share computational resources, an identification that can be based on utilizations, security capabilities, and/or other aspects of the edge devices. The flexible computation capacity orchestration service can be configured to generate one or more commands for effecting the creation of the device group and/or the sharing of data among the edge devices in the device group. It should be understood that this example is illustrative, and therefore should not be construed as being limiting in any way.

The edge devices in the device group can share data for computations with each other and generate, by performing computations on the data for computations, computed data, which can be returned to the edge device that originally offloaded computations to the other edge devices. When utilizations of the edge devices drop below defined levels, or when security requirements can no longer be complied with, the flexible computation capacity orchestration service and/or the flexible computation capacity orchestration application can be configured to cause use of the device group and/or to issue commands for causing and/or effecting the cessation of use of the device group. As such, computations can be offloaded from one edge device to other edge devices for a limited time, and members of a device group can change from time to time.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

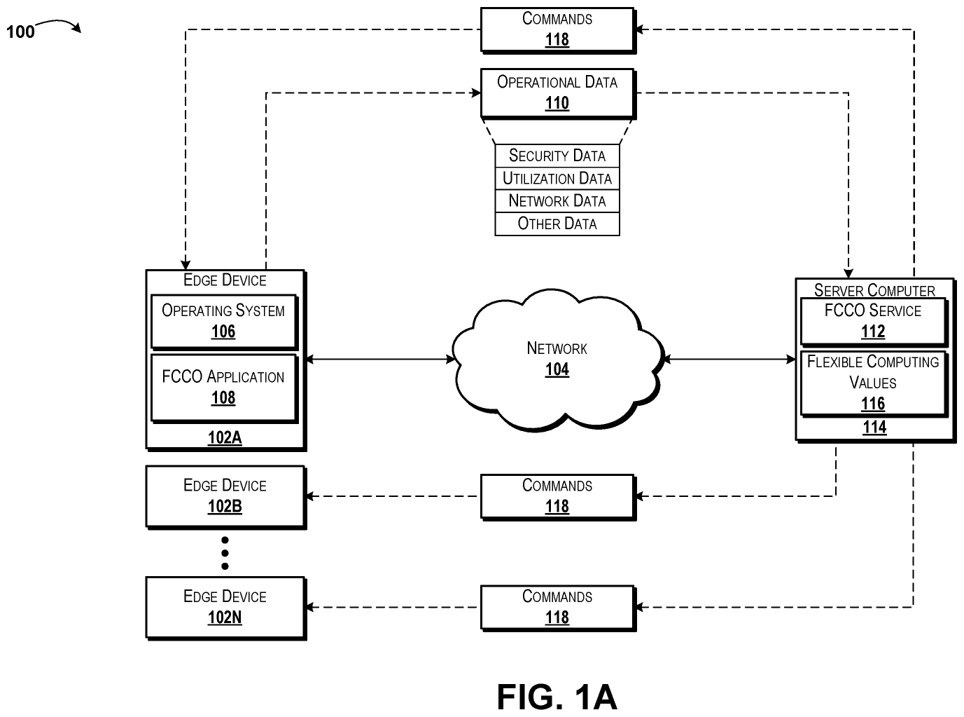

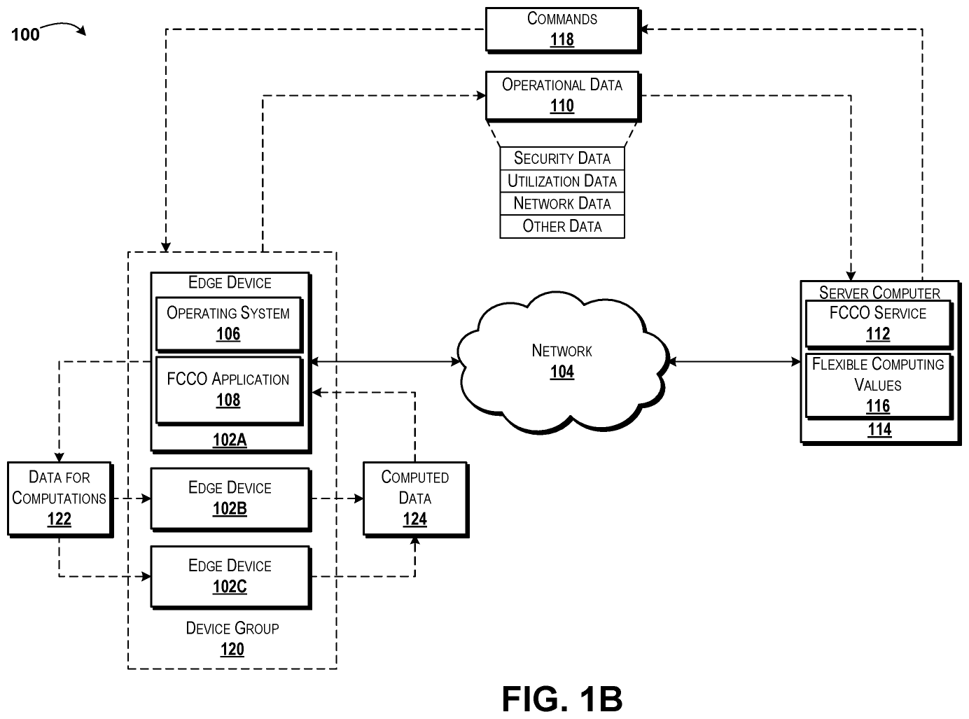

Referring now to FIGS. 1A-1B, aspects of an operating environment 100 for various embodiments of the concepts and technologies disclosed herein for flexible computation capacity orchestration will be described, according to an illustrative embodiment. The operating environment 100 shown in FIGS. 1A-1B includes one or more edge devices 102A-N(hereinafter collectively and/or generically referred to as “edge devices 102”). One or more of the edge devices 102 can operate in communication with and/or as a part of a communications network (“network”) 104, though this is not necessarily the case in all embodiments.

According to various embodiments, the functionality of one or more of the edge devices 102 may be provided by one or more server computers, desktop computers, mobile telephones, smartphones, Internet-of-Things (“IoT”) devices, cloud computing devices or resources (e.g., virtual machines, servers, etc.), laptop computers, set-top boxes, other computing systems, and the like. It should be understood that the functionality of the edge devices 102 may be provided by a single device, by two or more similar devices, and/or by two or more dissimilar devices. For purposes of describing the concepts and technologies disclosed herein, the edge devices 102 are described herein as a various types of devices including smartphones, personal computers, servers, and/or IoT devices. Based on the above, it should be understood that these example embodiments are illustrative, and should not be construed as being limiting in any way.

It should be noted that as used herein, the phrase “edge device” can refer to various types of devices including those listed above and/or other devices. Thus, while the term “edge device” is sometimes used to refer to an “edge router,” “gateway,” or the like, the term is not so limited herein. Rather, the phrase “edge device” is used expansively to refer to any device that attaches to and/or is provisioned services by the network 104 (e.g., a carrier network, etc.), and therefore can be accessed, controlled, and/or communicated with by other devices on or in communication with the network 104. It should be understood that this example is illustrative, and therefore should not be construed as being limiting in any way.

According to various embodiments of the concepts and technologies disclosed herein, one or more of the edge devices 102 can execute an operating system 106 and one or more application programs such as, for example, a flexible computation capacity orchestration application 108 (labeled “FCCO Application 108” in FIGS. 1A-1B). The operating system 106 can include a computer program that can control the operation of the edge devices 102. The flexible computation capacity orchestration application 108 can include an executable program that can be configured to execute on top of the operating system 106 to provide various functions as illustrated and described for flexible computation capacity orchestration.

In particular, the flexible computation capacity orchestration application 108 can be configured to monitor various performance and/or utilization characteristics of the associated edge device 102. For example, the flexible computation capacity orchestration application 108 can be configured to monitor processor utilization, memory utilization, network bandwidth utilization, and/or other utilization characteristics of the edge device 102. By way of example, the edge device 102 may be performing some computations on data (e.g., by way of executing one or more other applications (not illustrated in FIGS. 1A-1B)). The flexible computation capacity orchestration application 108 can be configured to monitor processor utilization of the edge device 102 during those computations. It should be understood that this example is illustrative, and therefore should not be construed as being limiting in any way.

The flexible computation capacity orchestration application 108 also can be configured to monitor security capabilities of the edge device 102. For example, the flexible computation capacity orchestration application 108 can be configured to determine what security policies and/or capabilities are available to and/or in use by the edge device 102 at any time. For example, the security capabilities can include an ability to encrypt communications; an ability to decrypt communications; an ability to create, host, and/or access a secure computing environment; an ability to use certain security protocols and/or policies; combinations thereof; or the like. Thus, the flexible computation capacity orchestration application 108 can be configured to determine what security protocols and/or capabilities are in use and/or available to the edge device 102 at any time. It should be understood that this example is illustrative, and therefore should not be construed as being limiting in any way.

The flexible computation capacity orchestration application 108 also can be configured to determine network capabilities and/or network utilization associated with the edge device 102. Thus, for example, the flexible computation capacity orchestration application 108 can be configured to monitor one or more network connections associated with the edge device 102, to determine total bandwidth available (e.g., to measure uplink speed, downlink speed, uplink capacity, downlink capacity, and/or utilizations of the uplink capacity and/or downlink capacity) for data transmissions. Because other networking aspects of the edge device 102 can be monitored and/or determined by the flexible computation capacity orchestration application 108, it should be understood that these examples are illustrative, and therefore should not be construed as being limiting in any way.

The flexible computation capacity orchestration application 108 can be configured to collect these and/or other information and to generate one or more releases or instances of operational data 110. From the above description, it can be appreciated that the operational data 110 can include, but is not limited to, security data, utilization data, network data, other data, combinations thereof, or the like. As noted above, the security data can describe zero, one, or more than one security capability and/or policy associated with the edge device 102 such as, for example, security protocols used by and/or available to the edge device 102; security policies used by and/or available to the edge device 102; security capabilities of the edge device 102; combinations thereof; or the like.

As noted above, the utilization data can describe zero, one, or more than one capability (e.g., processing capability, memory capability, etc.) and/or utilization associated with the edge device 102. Thus, the utilization data can describe, for example, one or more processor utilization, one or more memory utilization, combinations thereof, and/or the like for the edge device 102. The network data can describe zero, one, or more than one network capability and/or capacity of the edge device 102. Thus, the network data can describe, for example, a capacity and/or utilization of one or more network connection associated with the edge device 102, combinations thereof, or the like. It should be understood that these examples are illustrative, and therefore should not be construed as being limiting in any way.

The other data can include, for example, identity and/or address information associated with an edge device 102 that generated the operational data 110. Thus, for example, the other data can include data that can identify the edge device 102 such as, for example, an IP address for the edge device 102, a media access control (“MAC”) address for the edge device 102, an international mobile equipment identity (“IMEI”) for the edge device 102, an international mobile subscriber identity for the edge device 102, and/or other identifiers. The other data also can include, for example, data that can describe communication protocols used by the edge device 102, encryption and/or decryption technologies supported by the edge device 102, combinations thereof, or the like. Because other types of data illustrated and described herein can be included in the operational data 110 as the other data, it should be understood that these examples are illustrative, and therefore should not be construed as being limiting in any way.

According to various embodiments of the concepts and technologies disclosed herein, the edge devices 102 can generate, e.g., via execution of respective instances of the flexible computation capacity orchestration application 108 executed thereby, releases or instances of the operational data 110 at various times, intervals, and/or upon the occurrence of various types of triggers or trigger events. The edge devices 102 can provide the operational data 110 to one or more recipients such as, for example, a flexible computation capacity orchestration service 112. In various embodiments of the concepts and technologies disclosed herein, the flexible computation capacity orchestration service 112 can be provided by an application that can be executed and/or hosted by a computing device such as, for example, the server computer 114.

According to various embodiments, the functionality of the server computer 114 can be provided by one or more server computers, application servers, web servers, cloud computing devices or resources (e.g., virtual machines, servers, etc.), laptop computers, other computing systems, and the like. It should be understood that the functionality of the server computer 114 can be provided by a single device, by two or more similar devices, and/or by two or more dissimilar devices. For purposes of describing the concepts and technologies disclosed herein, the server computer 114 is described herein as a server that executes an application (e.g., a web server or application server). It should be understood, however, that this example embodiment is illustrative, and should not be construed as being limiting in any way.

The flexible computation capacity orchestration service 112 can receive the operational data 110 from one or more devices (e.g., one or more of the edge devices 102), and can determine, based on the operational data 110, if computations being performed by the device that provided the operational data 110 should be relocated to another device with compute capacity. In particular, as will be explained in more detail below, the flexible computation capacity orchestration service 112 can be configured to create and manage one or more groups of devices to share compute resources. In particular, the flexible computation capacity orchestration service 112 can be configured to analyze the operational data 110 to determine, for an edge device 102 that generated the particular instance of operational data 110 being analyzed, if computations of the edge device 102 should be moved to or shared with one or more other devices.

According to various embodiments of the concepts and technologies disclosed herein, for example, the flexible computation capacity orchestration service 112 can be configured to store one or more thresholds, limits (maximum limits and/or minimum limits), parameters, Booleans, and/or other values or integers (hereinafter referred to as “flexible computing values”) 116. The flexible computation capacity orchestration service 112 can be configured to analyze the various releases of the operational data 110 and determine, based on the one or more flexible computing values 116, if any computations should be moved from the edge device 102 that released the operational data 110 to one or more other edge devices 102, as will be explained in more detail hereinbelow.

According to some embodiments of the concepts and technologies disclosed herein, the flexible computing variables 116 can include an upper threshold limit such as, for example, a percent of utilization of processing resources that, if exceeded by an observed processor utilization (e.g., in a release of the operational data 110), can trigger the flexible computation capacity orchestration service 112 to effect movement of some computations (e.g., to offload some computations) from the edge device 102 that released the operational data 110 to another edge device 102. In some embodiments, as will be more clearly understood with reference to the disclosure hereinbelow, the flexible computation capacity orchestration service 112 can cause and/or effect the offloading of computations from the edge device 102 by initiating or otherwise triggering a use of a group of edge devices 102 for computations. It should be understood that this example is illustrative, and therefore should not be construed as being limiting in any way.

According to some other embodiments of the concepts and technologies disclosed herein, the flexible computing variables 116 can include an lower threshold limit such as, for example, a percent of utilization of processing resources that, if not met or exceeded by an observed processor utilization (e.g., in a release of the operational data 110), can trigger the flexible computation capacity orchestration service 112 to cease offloading of the computations from the edge device 102 that released the operational data 110 to another edge device 102. In some embodiments, as will be more clearly understood with reference to the disclosure hereinbelow, the flexible computation capacity orchestration service 112 can cause and/or effect the cessation of offloading of computations from the edge device 102 by terminating or otherwise ceasing use of a group of edge devices 102 for computations. It should be understood that this example is illustrative, and therefore should not be construed as being limiting in any way.

According to some other embodiments of the concepts and technologies disclosed herein, the flexible computing variables 116 can include a Boolean value such as “true/false,” “yes/no,” “zero/one,” or the like. The Boolean values can be used for utilizations, networking capacity, security parameters, or the like. Thus, if a Boolean value is or is not met (depending on the embodiment), the flexible computation capacity orchestration service 112 can start offloading computations from the edge device 102 that released the operational data 110 to another edge device 102; cease offloading of the computations from the edge device 102; and/or take other actions as illustrated and described herein. In some embodiments, as will be more clearly understood with reference to the disclosure hereinbelow, the flexible computation capacity orchestration service 112 can cause and/or effect the offloading of computations or cessation of offloading by initiating, changing, and/or ceasing use of a group of edge devices 102 for computations. It should be understood that this example is illustrative, and therefore should not be construed as being limiting in any way.

In various embodiments of the concepts and technologies disclosed herein, the flexible computation capacity orchestration service 112 can trigger the creation of groups of devices, the termination of the groups of devices, and/or the sharing or cessation of sharing of computations among the groups of devices by delivering one or more commands 118 to the one or more edge devices 102 that are included (or to be included) in the groups of devices. The flexible computation capacity orchestration service 112 also can be configured to generate the commands 118. The commands 118 can include computer-executable instructions that, when executed by the receiving edge device(s) 102, can cause the edge device(s) 102 to initiate, manage, enter, leave, and/or terminate a group of devices. According to various embodiments of the concepts and technologies disclosed herein, the commands 118 can be understood and implemented by the edge device(s) 102 that receive the commands 118 via execution of the flexible computation capacity orchestration application 108. Because the commands 118 can be implemented in additional and/or alternative manners, it should be understood that this example is illustrative, and therefore should not be construed as being limiting in any way.

For example, as shown in FIG. 1B, the flexible computation capacity orchestration service 112 can issue commands 118 to one or more edge device(s) 102. In some embodiments, the commands 118 can be sent to a single edge device 102 such as, for example, the edge device 102A, and the edge device 102A can implement the commands 118 to create the group of two or more edge devices 102 (hereinafter referred to as a device group 120). In some other embodiments, the flexible computation capacity orchestration service 112 can effect delivery of the commands 118 to each edge device 102 that is to be a part of the device group 120. In the illustrated embodiment shown in FIG. 1B, three edge devices 102 are shown as members of the device group 120. It should be understood that this example is illustrative, and therefore should not be construed as being limiting in any way.

The edge device 102A can be configured, for example via execution of the flexible computation capacity orchestration application 108, to offload computations to other edge devices 102 in its device group 120. For example, the edge device 102A can be configured to send data for computations 122 to one or more other edge devices 102 in the device group 120 for computations. Again, the example embodiment shown in FIG. 1B includes three edge devices 102 in the device group 120, namely the edge device 102B and the edge device 102C. It should be understood that this example is illustrative, and therefore should not be construed as being limiting in any way.

The edge devices 102B, 102C that receive the data for computations 122 can be configured, via execution of the flexible computation capacity orchestration application 108, to perform computations on the data for computations 122, thereby offloading processor load from the edge device 102A. In various embodiments of the concepts and technologies disclosed herein, the data for computations 122 can include an indicator that can indicate, to the receiving edge devices 102B, 102C, that the edge devices 102B, 102C are to perform computations on the data for computations 122. The edge devices 102B, 102C can perform the desired computations, and then send computed data 124 to the requesting edge device 102A. It should be understood that this example is illustrative, and therefore should not be construed as being limiting in any way.

During the computations that the device group 120 was created for are performed, and/or after these computations are completed, the device group 120 (e.g., each of the edge devices 102 in the device group 120), can issue releases of operational data 110 for tracking utilization of the edge devices 102 in the device group 120. The flexible computation capacity orchestration service 112 can be configured to determine, at any time and/or based on any release of the operational data 110, that the device group 120 is to be terminated and/or that the sharing of computational resources is to cease.

The flexible computation capacity orchestration service 112 can be configured to issue one or more commands 118 to the device group 120 (e.g., to one or more or each edge device 102 in the device group 120) to effect cessation of the device group 120. As such, it can be appreciated that the device group 120 can be of limited duration according to various embodiments. Namely, the device group 120 can persist from the time that computations are offloaded from one of the edge devices 102 in the device group 120 to another edge device 102 in the device group 120 until the offloading of the computations to the edge devices 102 and/or the performance of the computations themselves by the edge devices 102 are completed. It should be understood that this example is illustrative, and therefore should not be construed as being limiting in any way.

According to various embodiments of the concepts and technologies disclosed herein, the edge devices 102 to be added to a device group 120 can also or alternatively be identified based on security capabilities of the edge devices 102. For example, a particular process being performed by one of the edge devices 102 (e.g., the edge device 102A) may preferably be performed in a secure execution environment, using certain security protocols, using specific security technologies, and/or otherwise using or relying on specific security policies. According to various embodiments of the concepts and technologies disclosed herein, candidate edge devices 102 for a device group 120 can be added to the device group 120 based on the utilizations of the edge devices 102 and/or based on security capabilities of the edge devices 102.

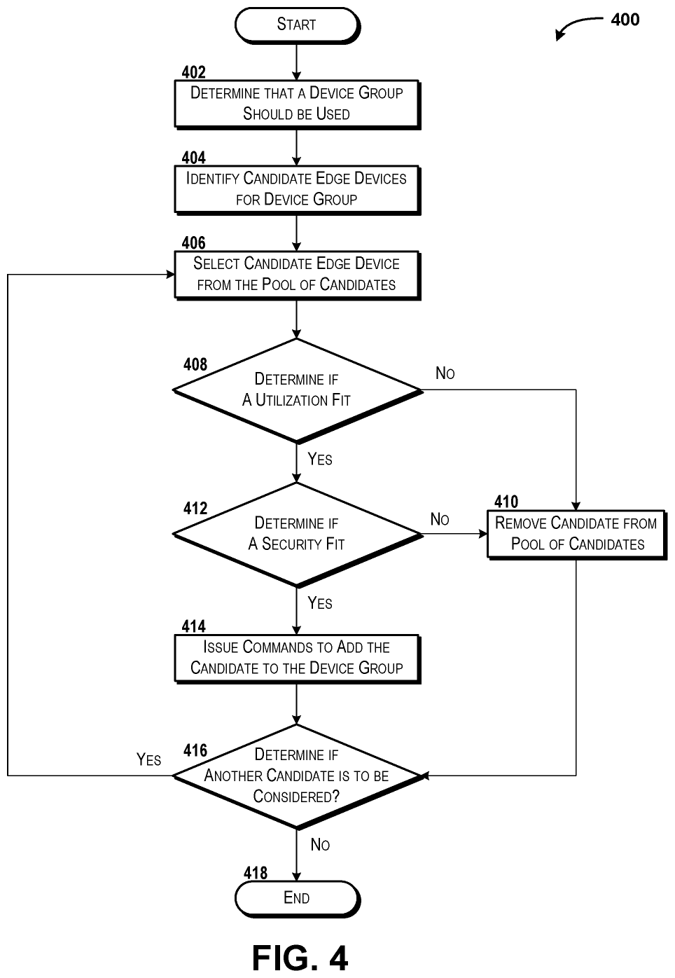

Thus, while some of the example embodiments illustrated and described herein for offloading computations to other edge devices 102 are described as relying on utilizations to identify the various edge devices 102 in a device group 120, it should be understood that security capabilities and/or security requirements can be used to limit what edge devices 102 may or may not be used in the device groups 120. Additional details of these embodiments will be illustrated and described herein, particularly with reference to FIG. 4.

In practice, two or more edge devices 102 can communicate with a network 104. The edge devices 102 can execute respective instances of a flexible computation capacity orchestration application 108. The flexible computation capacity orchestration application 108 can monitor performance of the respective edge device 102 to detect computations that can/should be offloaded to other edge devices 102 and/or to determine utilizations of the edge device 102. According to various embodiments, the flexible computation capacity orchestration application 108 can be configured to generate one or more instances of operational data 110.

The operational data 110 can include security data that can define security capabilities of the edge device 102; utilization data that can define processor, memory, and/or other resource utilization of the edge device 102; network data that can define network abilities and/or network utilization of the edge device 102; and/or other data that can identify the edge device 102 and/or provide other information associated with the edge device 102 such as addresses, or the like. The edge device 102 can provide the operational data 110 to a flexible computation capacity orchestration service 112, which in some instances can be hosted and/or executed by a server computer 114.

The flexible computation capacity orchestration service 112 can be configured to analyze the operational data 110 to determine if one or more computations should be offloaded from the edge device 102 and, if so, to which other edge device(s) 102. In some embodiments, the flexible computation capacity orchestration service 112 can identify and/or determine the edge device(s) 102 that are to perform the computations based on operational data 110 associated with the other edge devices 102. As noted above, the operational data 110 can define security abilities and/or capabilities associated with the edge devices 102; processor, memory, and/or other resource utilizations associated with the edge devices 102; network utilizations associated with the edge devices 102; other information associated with the edge devices 102; and the like. It should be understood that the utilization data of the operational data 110 can define a utilization of a networking device of the edge device 102, while the network data can define available network resources (e.g., network bandwidth, etc.) for the edge device 102. It should be understood that this example is illustrative, and therefore should not be construed as being limiting in any way.

Based on these and/or other considerations, the flexible computation capacity orchestration service 112 can determine if computations should be offloaded from the edge device 102 to other edge devices 102. In various embodiments, this offloading can be accomplished in embodiments of the concepts and technologies disclosed herein by creating a device group 120 that can share computational resources as illustrated and described herein. Thus, the flexible computation capacity orchestration service 112 can identify the edge devices 102 that should be added to the device group 120 to share computational resources, an identification that can be based on utilizations, security capabilities, and/or other aspects of the edge devices 102. The flexible computation capacity orchestration service 112 can be configured to generate one or more commands 118 for effecting the creation of the device group 120 and/or the sharing of data among the edge devices 102 in the device group 120. It should be understood that this example is illustrative, and therefore should not be construed as being limiting in any way.

The edge devices 102 in the device group 120 can share data for computations 122 with each other and generate, by performing computations on the data for computations 122, computed data 124, which can be returned to the edge device 102 that originally offloaded computations to the other edge devices 102. When utilizations of the edge devices 102 drop below defined levels, or when security requirements can no longer be complied with, the flexible computation capacity orchestration service 112 and/or the flexible computation capacity orchestration application 108 can be configured to cause use of the device group 120 and/or to issue commands 118 for effecting the cessation of use of the device group 120. As such, computations can be offloaded from one edge device 102 to other edge devices 102 for a limited time, and members of a device group 120 can change from time to time. These and other aspects of the concepts and technologies disclosed herein will be illustrated and described in additional detail hereinbelow.

FIGS. 1A-1B illustrate four edge devices 102A, 102B, 102C, and 102N;
one network 104; one server computer 114; and one device group 120. It should be understood, however, that various implementations of the operating environment 100 can include two or more than two edge devices 102; one or more than one network 104; zero, one, or more than one server computer 114; and/or one or more than one device group 120. As such, the illustrated embodiment should be understood as being illustrative, and should not be construed as being limiting in any way.

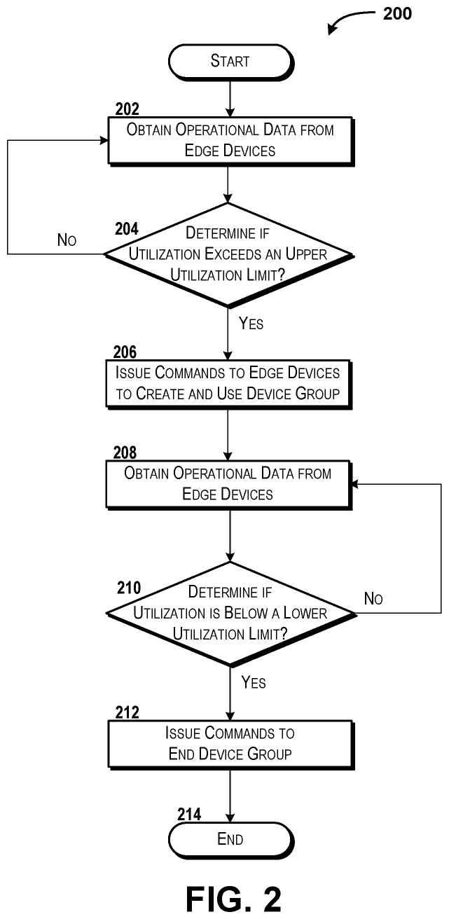

Turning now to FIG. 2, aspects of a method 200 for orchestrating a device group to provide flexible computation capacity will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the edge devices 102 and/or the server computer 114, to perform one or more operations and/or causing the processor to direct other components of the computing system or device to perform one or more of the operations.

For purposes of illustrating and describing the concepts of the present disclosure, the method 200 is described herein as being performed by the server computer 114 via execution of one or more software modules such as, for example, the flexible computation capacity orchestration service 112. It should be understood that additional and/or alternative devices and/or network nodes can provide the functionality described herein via execution of one or more modules, applications, and/or other software including, but not limited to, the flexible computation capacity orchestration service 112. Thus, the illustrated embodiments are illustrative, and should not be viewed as being limiting in any way.

The method 200 begins at operation 202. At operation 202, the server computer 114 can obtain operational data 110 from an edge device 102. As explained above with reference to FIGS. 1A-1B, the operational data 110 can include security data, utilization data, network data, and/or other data associated with the edge device 102 that generated the operational data 110. According to various embodiments of the method 200 illustrated and described in FIG. 2, the operational data can include a utilization data that includes a processor utilization associated with the edge device 102, security data that can define one or more security capabilities of the edge device 102, network data that can describe one or more network utilizations and/or capabilities, other data, combinations thereof, or the like. Because the operational data 110 can include additional and/or alternative information as illustrated and described herein, it should be understood that this example is illustrative, and therefore should not be construed as being limiting in any way.

From operation 202, the method 200 can proceed to operation 204. At operation 204, the server computer 114 can determine, based on an analysis of the operational data 110 obtained in operation 202, if a utilization indicated in the release of the operational data 110 obtained in operation 202 (e.g., a processor utilization, memory utilization, network utilization, etc.) meets or exceeds (i.e., satisfies) an upper utilization limit (e.g., a threshold). According to various embodiments, operation 204 can correspond to the server computer 114 determining if a processor utilization of the edge device 102, as indicated in the release of the operational data 110 obtained in operation 202, meets or exceeds an upper utilization limit for processor utilization.

In various embodiments, as explained above with reference to FIGS. 1A-1B, the flexible computing variables 116 can include utilization threshold limits such as upper limits, lower limits, or the like. In such embodiments, if the upper utilization limit is met or exceeded, the server computer 114 can perform operations to offload computations from the edge device 102 from which the operational data 110 was received in operation 202. It should be understood that this example is illustrative, and therefore should not be construed as being limiting in any way.

In some embodiments of the concepts and technologies disclosed herein, the upper utilization limit can include a utilization (as indicated in the operational data 110) that is greater than or equal to fifty percent, sixty percent, seventy percent, eighty percent, ninety percent, ninety five percent, and/or other percentages. Because the utilization percentage can be set based on various considerations and/or can be dynamically set based on known or expected processes to be performed by the edge devices 102, it should be understood that these examples are illustrative, and therefore should not be construed as being limiting in any way.

If the server computer 114 determines, in operation 204, that the utilization indicated in the release of the operational data 110 obtained in operation 202 does not meet or exceed an upper utilization limit, the method 200 can return to operation 202, at which the server computer 114 can obtain a new release of the operational data 110. It should be appreciated that the flow of the method 200 that returns to operation 202 may pause until a new release of the operational data 110 is released by the edge devices 102. It should be understood that this example is illustrative, and therefore should not be construed as being limiting in any way.

If the server computer 114 determines, in operation 204, that the upper utilization limit is met or exceeded by the utilization indicated in the release of the operational data 110 obtained in operation 202, the method 200 can proceed to operation 206. At operation 206, the server computer 114 can issue one or more commands 118 to one or more edge devices 102 to create, join, and/or use a device group 120.

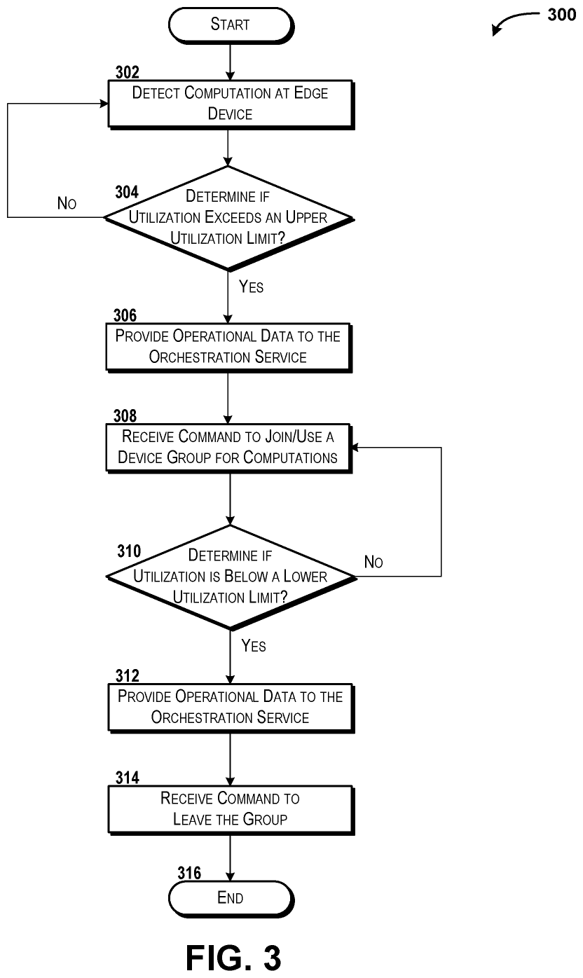

As explained above, the commands 118 issued in operation 206 can be generated by the server computer 114. The commands 118 can include computer-executable code and/or other instructions that, when received and/or implemented by an edge device 102, can cause the edge device 102 that received the command(s) 118 to create, join, and/or use a device group 120. As noted above, the edge devices 102 can implement the commands 118 via execution of the flexible computation capacity orchestration application 108, as will be explained in more detail below with reference to FIG. 3. It should be understood that this example is illustrative, and therefore should not be construed as being limiting in any way.

From operation 206, the method 200 can proceed to operation 208. At operation 208, the server computer 114 can obtain operational data 110 from the device group 120. In some embodiments, operation 208 can correspond to the server computer 114 obtaining operational data 110 from the two or more edge devices 102 that are included in the device group 120. In some embodiments, though not illustrated in FIG. 2, the server computer 114 can request the operational data 110 from the device group 120 and/or the edge devices 102 included in the device group 120.

In some other embodiments, the edge devices 102 in the device group 120 can be configured, for example via execution of the flexible computation capacity orchestration application 108, to provide releases of the operational data 110 at certain times while a member of a device group 120 (e.g., at set time intervals, when changes in utilization are detected, when offloaded computations start to be executed, when offloaded computations are completed, etc.). Thus, it can be appreciated that the operational data 110 obtained in operation 208 can be obtained at various times and/or can be obtained more than once by the server computer 114. It should be understood that this example is illustrative, and therefore should not be construed as being limiting in any way.

From operation 208, the method 200 can proceed to operation 210. At operation 210, the server computer 114 can determine, based on an analysis of the operational data 110 obtained in operation 208, if utilizations of one or more of the edge devices 102 in the device group 120, as indicated in the release of the operational data 110 obtained in operation 208, meets or drops below (i.e., satisfies) a lower utilization limit. It can be appreciated that in various embodiments of the concepts and technologies disclosed herein, the server computer 114 can consider an average utilization (e.g., an average processor utilization) of the edge devices 102 in the device group 120 in operation 210 to determine if the average processor utilizations of the edge devices 102 meets or drops below a defined lower utilization limit. It should be understood that this example is illustrative, and therefore should not be construed as being limiting in any way.

Thus, some example embodiments of operation 210 can correspond to the server computer 114 determining if the processor utilizations of the edge devices 102 in the device group 120 have dropped below a defined minimum limit, which can be construed by the server computer 114 as indicating that one or more of the edge devices 102 should be removed from the device group 120 and/or that the device group 120 should be disbanded, terminated, and/or otherwise should cease to be used for offloading computations from the edge device 102 from which the operational data 110 was obtained in operation 202. It should be understood that this example is illustrative, and therefore should not be construed as being limiting in any way.

In some example embodiments of the concepts and technologies disclosed herein, the lower utilization limit can include a utilization (as indicated in the operational data 110) that is equal to or less than fifty percent, forty percent, thirty percent, twenty percent, ten percent, five percent, and/or other percentages. Because the utilization percentage can be set based on various considerations and/or can be dynamically set based on known or expected processes to be performed by the edge devices 102, it should be understood that these examples are illustrative, and therefore should not be construed as being limiting in any way.

If the server computer 114 determines, in operation 210, that the utilization indicated in the release of the operational data 110 obtained in operation 202 does not meet or drop below the lower utilization limit, the method 200 can return to operation 208, at which the server computer 114 can obtain a new release of the operational data 110 from the device group 120 and/or the edge devices 102 in the device group 120. It should be appreciated that the flow of the method 200 that returns to operation 208 may pause until a new release of the operational data 110 is released by the edge devices 102 of the device group 120. It should be understood that this example is illustrative, and therefore should not be construed as being limiting in any way.

If the server computer 114 determines, in operation 210, that the utilizations of the edge devices 102 in the device group 120, or average utilization of the edge devices 102 in the device group 120, meets or drops below the lower utilization limit, the method 200 can proceed to operation 212. At operation 212, the server computer 114 can issue one or more commands 118 to one or more edge devices 102 in the device group 120 to leave or end the device group 120.

As explained above, the commands 118 issued in operation 212 can be generated by the server computer 114. The commands 118 can include computer-executable code and/or other instructions that, when received and/or implemented by one or more of the edge devices 102, can cause the edge devices 102 that receive the command(s) 118 to leave, cease use of, and/or terminate the device group 120. As noted above, the edge devices 102 can implement the commands 118 via execution of the flexible computation capacity orchestration application 108, as will be explained in more detail below with reference to FIG. 3. It should be understood that this example is illustrative, and therefore should not be construed as being limiting in any way.

From operation 212, the method 200 can proceed to operation 214. The method 200 can end at operation 214.

Turning now to FIG. 3, aspects of a method 300 for joining and leaving a device group that provides flexible computation capacity will be described in detail, according to an illustrative embodiment. For purposes of illustrating and describing the concepts of the present disclosure, the method 300 is described herein as being performed by one of the edge devices 102. For purposes of simplifying the description of FIG. 3, the method 300 is described as being performed by the edge device 102A via execution of one or more software modules such as, for example, the flexible computation capacity orchestration application 108. It should be understood that additional and/or alternative devices and/or network nodes can provide the functionality described herein via execution of one or more modules, applications, and/or other software including, but not limited to, the flexible computation capacity orchestration application 108. Thus, the illustrated embodiments are illustrative, and should not be viewed as being limiting in any way.

The method 300 begins at operation 302. At operation 302, the edge device 102A can detect one or more computation(s) at the edge device 102A. The computations detected in operation 302 can correspond, in some embodiments, to computations that are determined to exceed, or determined to be likely to exceed, a defined processor utilization. It can be appreciated that operation 302 can correspond to the edge device 102A determining, via execution of the flexible computation capacity orchestration application 108, that processor utilization is likely to exceed a defined processor utilization threshold. It should be understood that this example is illustrative, and therefore should not be construed as being limiting in any way.

According to various embodiments of the concepts and technologies disclosed herein, the edge device 102A can determine that the processor utilization is likely to exceed a defined processor utilization threshold based on a type of computations detected at the edge device 102A, based on defined configurations and/or settings, etc. In some other embodiments, operation 302 can correspond to the edge device 102A determining that any sort of computation is occurring at the edge device 102A. Thus, it can be appreciated that the method 300 can include detecting any computation and/or detecting only computations associated with certain types of processes or procedures that are expected to exceed one or more defined computation thresholds. It should be understood that these examples are illustrative, and therefore should not be construed as being limiting in any way.

From operation 302, the method 300 can proceed to operation 304. At operation 304, the edge device 102A can determine if a utilization of the edge device 102A (e.g., a processor utilization, memory utilization, network utilization, etc.) meets or exceeds an upper utilization limit (e.g., a threshold). Thus, although not separately illustrated in FIG. 3, it should be understood that operation 304 can include the edge device 102A determining its utilization (e.g., the processor utilization of the edge device 102A, the memory utilization of the edge device 102A, the network utilization of the edge device 102A, combinations thereof, or the like).

According to various embodiments, operation 304 can correspond to the edge device 102A determining if a processor utilization of the edge device 102 meets or exceeds an upper utilization limit for processor utilization. The upper utilization limit can be defined by settings, configurations, or the like, and/or can be defined and/or used by the flexible computation capacity orchestration application 108. It should be understood that this example is illustrative, and therefore should not be construed as being limiting in any way.

In some embodiments of the concepts and technologies disclosed herein, the upper utilization limit can include a utilization (as indicated in the operational data 110) that is greater than or equal to fifty percent, sixty percent, seventy percent, eighty percent, ninety percent, ninety five percent, and/or other percentages. Because the utilization percentage can be set based on various considerations and/or can be dynamically set based on known or expected processes to be performed by the edge device 102A, it should be understood that these examples are illustrative, and therefore should not be construed as being limiting in any way.

If the edge device 102A determines, in operation 304, that the utilization of the edge device 102A (e.g., the processor utilization of the edge device 102A) does not meet or exceed an upper utilization limit, the method 300 can return to operation 302, at which the edge device 102A can detect another computation at the edge device 102A. It should be appreciated that the flow of the method 300 that returns to operation 302 may pause until a new computation is detected, and therefore the flow of the method 300 may not immediately proceed from operation 302 back to operation 304. It should be understood that this example is illustrative, and therefore should not be construed as being limiting in any way.

If the edge device 102A determines, in operation 304, that the upper utilization limit is met or exceeded by the utilization of the edge device 102A, the method 300 can proceed to operation 306. At operation 306, the edge device 102A can provide operational data 110 to the flexible computation capacity orchestration service 112. Thus, it can be appreciated that the operational data 110 illustrated and described herein may be provided to the flexible computation capacity orchestration service 112 by the edge device 102A only when a utilization of the edge device 102A meets or exceeds some known threshold. It should be understood that this example is illustrative, and therefore should not be construed as being limiting in any way.

From operation 306, the method 300 can proceed to operation 308. At operation 308, the edge device 102A can receive a command 118 to join and/or use a device group 120 for computations (e.g., computations associated with the computation detected in operation 302, or other computations). According to various embodiments of the concepts and technologies disclosed herein, the command 118 received in operation 308 can be received form the flexible computation capacity orchestration service 112 (e.g., from the server computer 114), though this is not necessarily the case in all embodiments.

As explained above, the command 118 received in operation 308 can correspond to computer-executable code and/or other instructions that, when implemented by the edge device 102A (e.g., via execution of the flexible computation capacity orchestration application 108), can cause the edge device 102A to join a device group 120, to offload computations to the edge devices 102 in the device group 120, to request creation of the device group 120, etc. It should be understood that this example is illustrative, and therefore should not be construed as being limiting in any way.

Although not separately illustrated in FIG. 3, it can be appreciated that the edge device 102A can join and/or use a device group 120. Thus, the edge device 102A can send, to one or more other edge devices 102 in the device group 120, data for computations 122 as illustrated and described herein. Similarly, the edge device 102A can receive, from the edge devices 102 in the device group 120, computed data 124 that can correspond to the data generated by the offloaded computations performed on the data for computations 122. It should be understood that this example is illustrative, and therefore should not be construed as being limiting in any way.

Thus, it can similarly be appreciated that the edge device 102B (in the example embodiment shown in FIG. 1B) can receive, from the edge device 102A, the data for computations 122. The edge device 102B can perform the computations on the data for computations 122 and provide, to the edge device 102A, the computed data 124. It should be understood that this example is illustrative, and therefore should not be construed as being limiting in any way.

From operation 308, the method 300 can proceed to operation 310. At operation 310, the edge device 102A can determine if a utilization of the edge device 102A meets or drops below a lower utilization limit. Thus, although not separately illustrated in FIG. 3, it should be understood that operation 310 can include the edge device 102A determining its utilization (e.g., the processor utilization of the edge device 102A, the memory utilization of the edge device 102A, the network utilization of the edge device 102A, combinations thereof, or the like). It should be understood that this example is illustrative, and therefore should not be construed as being limiting in any way.

Some example embodiments of operation 310 can correspond to the edge device 102A determining that its processor utilization (or other utilization in some embodiments) has dropped below a defined minimum limit, which in some embodiments can be understood by the edge device 102A as indicating that the edge device 102A should leave the device group 120 and/or that the device group 120 should be disbanded, terminated, and/or otherwise should cease being used for offloading computations from the edge device 102A to the other edge devices 102 in the device group 120. It should be understood that this example is illustrative, and therefore should not be construed as being limiting in any way.

In some example embodiments of the concepts and technologies disclosed herein, the lower utilization limit can include a utilization (as indicated in the operational data 110) that is equal to or less than fifty percent, forty percent, thirty percent, twenty percent, ten percent, five percent, and/or other percentages. Because the utilization percentage can be set based on various considerations and/or can be dynamically set based on known or expected processes to be performed by the edge device 102A, it should be understood that these examples are illustrative, and therefore should not be construed as being limiting in any way.

If the edge device 102A determines, in operation 310, that the utilization of the edge device 102A does not meet or drop below the lower utilization limit, the method 300 can repeat operation 310, at which the edge device 102A can again determine its utilization (e.g., the processor utilization of the edge device 102A, the memory utilization of the edge device 102A, the network utilization of the edge device 102A, combinations thereof, or the like), and can again determine if a utilization of the edge device 102A meets or drops below a lower utilization limit. Thus, it can be appreciated that execution of the method 300 can pause at operation 310 until the edge device 102A determines, in any iteration of operation 310, that a utilization of the edge device 102A meets or drops below a lower utilization limit. It should be understood that this example is illustrative, and therefore should not be construed as being limiting in any way.

If the edge device 102A determines, in any iteration of operation 310, that the utilization of the edge device 102A meets or drops below the lower utilization limit, the method 300 can proceed to operation 312. At operation 312, the edge device 102A can again provide operational data 110 to the flexible computation capacity orchestration service 112 (e.g., to the server computer 114). As explained above, the server computer 114 can determine if the edge device 102A should remain in the device group 120 or leave the device group 120.

From operation 312, the method 300 can proceed to operation 314. At operation 314, the edge device 102A can receive one or more commands 118 to leave the device group 120 and/or to end, disband, and/or otherwise terminate the device group 120. As explained above, the commands 118 received in operation 314 can be generated by the server computer 114. The commands 118 can include computer-executable code and/or other instructions that, when received and/or implemented by the edge device 102A, can cause the edge device 102A to leave, cease use of, and/or terminate the device group 120. In some embodiments, the edge device 102A can also instruct other edge devices 102 in the device group 120 to leave the device group 120, though this is not necessarily the case. As noted above, the edge device 102A can implement the commands 118 via execution of the flexible computation capacity orchestration application 108, in some embodiments. It should be understood that this example is illustrative, and therefore should not be construed as being limiting in any way.

From operation 314, the method 300 can proceed to operation 316. The method 300 can end at operation 316.

Turning now to FIG. 4, aspects of a method 400 for identifying devices for a device group to provide flexible computation capacity will be described in detail, according to an illustrative embodiment. For purposes of illustrating and describing the concepts of the present disclosure, the method 400 is described herein as being performed by the server computer 114 via execution of one or more software modules such as, for example, the flexible computation capacity orchestration service 112. It should be understood that additional and/or alternative devices and/or network nodes can provide the functionality described herein via execution of one or more modules, applications, and/or other software including, but not limited to, the flexible computation capacity orchestration service 112. Thus, the illustrated embodiments are illustrative, and should not be viewed as being limiting in any way.

The method 400 begins at operation 402. At operation 402, the server computer 114 can determine that a device group 120 should be used. According to various embodiments of the concepts and technologies disclosed herein, operation 402 can correspond to the server computer 114 determining that a device group 120 should be used to perform various computations that are to be offloaded from one edge device 102 (e.g., the edge device 102A) to one or more other edge devices 102 (e.g., one or more of the edge device 102B, the edge device 102C, the edge device 102N, and/or other edge devices 102). It should be understood that this example is illustrative, and therefore should not be construed as being limiting in any way.

From operation 402, the method 400 can proceed to operation 404. At operation 404, the server computer 114 can identify two or more candidate edge devices 102 for a device group 120. According to various embodiments of the concepts and technologies disclosed herein, the candidate edge devices 102 can be identified by the server computer 114 obtaining utilization data from two or more edge devices 102. According to various embodiments of the concepts and technologies disclosed herein, the server computer 114 can be configured to identify edge devices 102 that are eligible to be candidate edge devices 102 for a device group 120, though not separately illustrated in FIG. 4. As such, operation 404 can include the server computer 114 obtaining utilization data (e.g., operational data 110) from the edge devices 102 that are eligible to e candidates for the device group 120.

According to various embodiments of the concepts and technologies disclosed herein, the candidates for the device group 120 can be determined or identified by the server computer 114 in one or more ways. In some embodiments, a first edge device 102 can identify one or more other edge devices 102 that can be included in a device group 120 that includes the first edge device 102. In some embodiments, this indication can be made via the flexible computation capacity orchestration application 108 and/or via interactions with the flexible computation capacity orchestration service 112.

In some other embodiments, the flexible computation capacity orchestration service 112 can obtain opt-in indications from two or more edge devices 102 that are willing to share computational and/or other resources with other edge devices 102. Such devices (that opt-in or otherwise indicate a willingness to share resources) can be included in a pool of candidates for the device group 120. In yet other embodiments, the server computer 114 can be configured to identify candidates for the device group 120 based on utilization data for the edge devices 102. For example, the server computer 114 can search for edge devices 102 having utilizations under a set threshold and include any such edge devices 102 in the pool of candidates for the device group 120. Because the candidates for the device group 120 can be identified in additional and/or alternative manners, it should be understood that these examples are illustrative, and therefore should not be construed as being limiting in any way.

From operation 404, the method 400 can proceed to operation 406. At operation 406, the server computer 114 can identify a candidate edge device 102 for the device group 120. Thus, in operation 406, the server computer 114 can select, from the pool of candidates that can be identified as explained above, a candidate for adding to the device group 120 (e.g., a candidate device to which computations may be offloaded from an edge device 102). The selection of the candidate in operation 406 can be made in any way, including random selection, selection based on utilization, selection based on capacity, combinations thereof, or the like.

From operation 406, the method 400 can proceed to operation 408. At operation 408, the server computer 114 can determine, for the candidate edge device 102 selected in operation 406, if the candidate edge device 102 is a utilization fit for the device group 120. In some embodiments, a candidate edge device 102 can be rejected (e.g., may not be added to the device group 120) if its utilization (e.g., a processor utilization, memory utilization, network utilization, etc.) is over a defined level such as fifty percent. Conversely, in some embodiments a candidate edge device 102 can be determined to be a fit (e.g., may be added to the device group 120) if its utilization (e.g., a processor utilization, memory utilization, network utilization, etc.) is under a defined level such as fifty percent. Because any levels can be defined with respect to operation 408, it should be understood that these examples are illustrative, and therefore should not be construed as being limiting in any way.

If the server computer 114 determines, in operation 408, that the candidate edge device 102 has a utilization that is not a utilization fit for addition to a device group 120, the method 400 can proceed to operation 410, and the candidate edge device 102 selected in operation 406 can be removed from the pool of candidate edge devices 102.

If the server computer 114 determines, in operation 408, that the candidate edge device 102 has a utilization that is a utilization fit for addition to a device group 120, the method 400 can proceed to operation 412. At operation 412, the server computer 114 can determine, for the candidate edge device 102 selected in operation 406, if the candidate edge device 102 is a security fit for the device group 120. In some embodiments, a candidate edge device 102 can be rejected (e.g., may not be added to the device group 120) if its utilization (e.g., a processor utilization, memory utilization, network utilization, etc.) is over a defined level such as fifty percent. Conversely, in some embodiments a candidate edge device 102 can be determined to be a fit (e.g., may be added to the device group 120) if its utilization (e.g., a processor utilization, memory utilization, network utilization, etc.) is under a defined level such as fifty percent. Because any levels can be defined with respect to operation 408, it should be understood that these examples are illustrative, and therefore should not be construed as being limiting in any way.

At operation 412, the server computer 114 can determine, for the candidate edge device 102 selected in operation 406, if the candidate edge device 102 is a security fit for the device group 120. As explained above, edge devices 102 can be determined to be a candidate for a device group 120 based on various parameters such as, for example, data included in the operational data 110. In some embodiments, a candidate edge device 102 can be rejected (e.g., may not be added to the device group 120) if the candidate edge device 102 does not have the ability to comply with specified security protocols or requirements. For example, if offloaded computations must be performed in a secure execution environment, the candidate edge device 102 may be rejected if the candidate edge device 102 cannot provide or execute in a secure execution environment.

In another example, certain encryption and/or decryption technologies or other protocols may be required for the computations (and/or the sharing of data used for or generated by those computations). As such, the candidate edge device 102 may be rejected if the candidate edge device cannot use the specified encryption and/or decryption technologies or other protocols. Conversely, candidate edge devices 102 that can comply with specified security protocols or requirements may be determined to be good candidates for the device group 120. Because other security considerations can be used to determine if a candidate edge device 102 is or is not a security fit for the device group 120, it should be understood that the above examples are illustrative, and therefore should not be construed as being limiting in any way.

If the server computer 114 determines, in operation 412, that the candidate edge device 102 is not a security fit for addition to a device group 120, the method 400 can proceed to operation 410, and the candidate edge device 102 selected in operation 406 can be removed from the pool of candidate edge devices 102. If the server computer 114 determines, in operation 412, that the candidate edge device 102 is a security fit for addition to a device group 120, the method 400 can proceed to operation 414.

At operation 414, the server computer 114 can issue one or more commands 118 to add the candidate edge device 102 selected in operation 406 to the device group 120. The commands 118 issued in operation 414 can be generated by the server computer 114. The commands 118 can include computer-executable code and/or other instructions that, when received and/or implemented by one or more of the edge devices 102, can cause the edge devices 102 that receive the command(s) 118 to cause the candidate edge device 102 selected in operation 406 to join the device group 120. As noted above, the edge devices 102 can implement the commands 118 via execution of the flexible computation capacity orchestration application 108, in some embodiments. It should be understood that this example is illustrative, and therefore should not be construed as being limiting in any way.

From operation 414, the method 400 can proceed to operation 416. The method 400 also can proceed to operation 416 from operation 410. At operation 416, the server computer 114 can determine if another candidate edge device 102 should be considered for addition to the device group 120. In some embodiments, the determination of operation 416 can be made by the server computer 114 determining if the device group 120 is full (e.g., if enough edge devices 102 are included in the device group 120 to perform the computations that are to be offloaded to the device group 120). In some embodiments, the server computer 114 can make the determination of operation 416 by determining if another candidate edge device 102 is available in the pool of candidates for consideration. Because the determination of operation 416 can be made in additional and/or alternative manners, it should be understood that these examples are illustrative, and therefore should not be construed as being limiting in any way.

If the server computer 114 determines, in operation 416, that another candidate edge device 102 should be considered for addition to the device group 120, the method 400 can return to operation 406, and the server computer 114 can select another candidate edge device 102 for consideration. Thus, it should be appreciated that operations 406-416 can be iterated until the server computer 114 determines, in any iteration of operation 416, that another candidate edge device 102 should not be considered.

If the server computer 114 determines, in any iteration of operation 416, that another candidate edge device 102 should not be considered for addition to the device group, the method 400 can proceed to operation 416. The method 400 can end at operation 416.

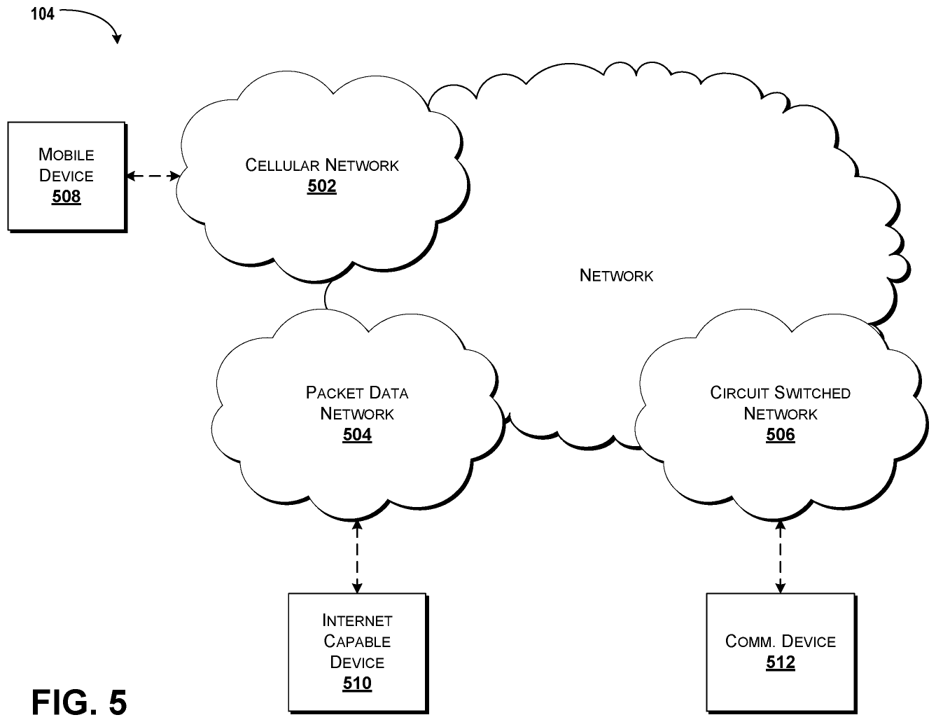

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSDPA), and HSPA+. The cellular network 502 also is compatible with 4G mobile communications standards, 5G mobile communications standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

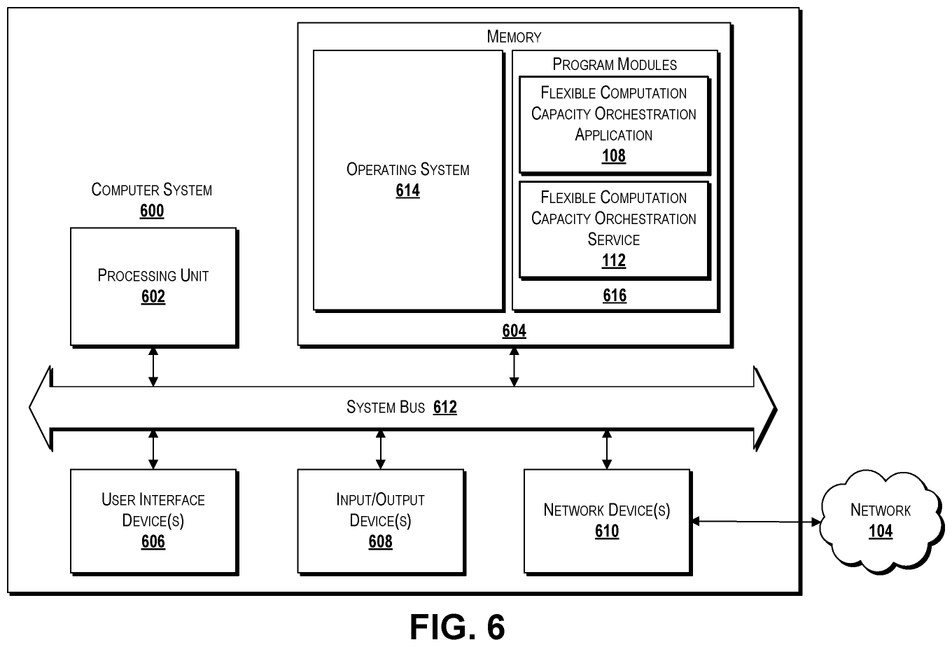

FIG. 6 is a block diagram illustrating a computer system 600 configured to provide the functionality described herein for providing flexible computation capacity orchestration, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 can include the flexible computation capacity orchestration application 108 and/or the flexible computation capacity orchestration service 112. These and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein.

It can be appreciated that, at least by virtue of the instructions embodying the methods 200, 300, and 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the operational data 110, the flexible computing variables 116, the commands 118, the data for computations 122, the computed data 124, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

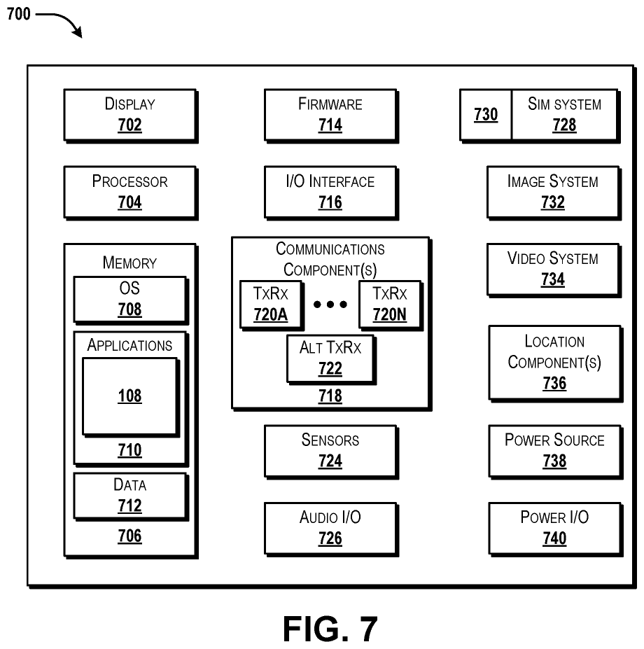

Turning now to FIG. 7, an illustrative mobile device 700 and components thereof will be described. In some embodiments, one or more of the edge devices 102 described above with reference to FIGS. 1A-6 can be configured as and/or can have an architecture similar or identical to the mobile device 700 described herein in FIG. 7. It should be understood, however, that the edge device 102 may or may not include the functionality described herein with reference to FIG. 7. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the flexible computation capacity orchestration application 108, the flexible computation capacity orchestration service 112, other computer-executable instructions stored in a memory 706, or the like. In some embodiments, the applications 710 also can include a UI application (not illustrated in FIG. 7).

The UI application can interface with the operating system 708, such as the operating system 106 shown in FIGS. 1A-1B, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, flexible computation capacity orchestration application 108, the flexible computation capacity orchestration service 112, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, the operational data 110, the flexible computing variables 116, the commands 118, the data for computations 122, the computed data 124, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSDPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N(hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

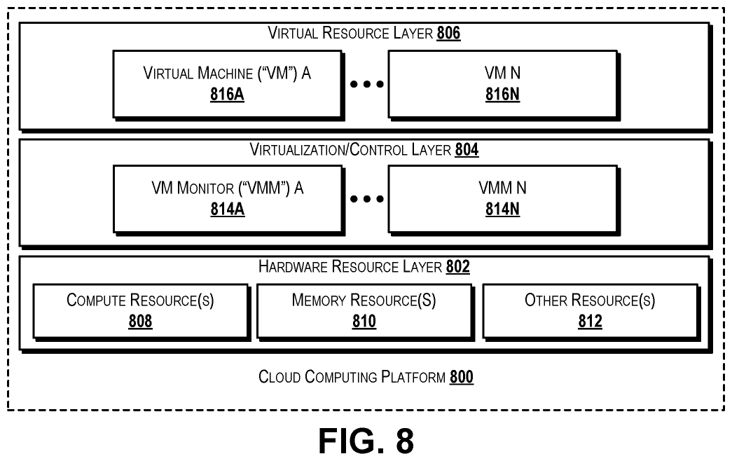

FIG. 8 illustrates an illustrative architecture for a cloud computing platform 800 that can be capable of executing the software components described herein for providing flexible computation capacity orchestration and/or for interacting with the flexible computation capacity orchestration application 108 and/or the flexible computation capacity orchestration service 112. Thus, it can be appreciated that in some embodiments of the concepts and technologies disclosed herein, the cloud computing platform 800 illustrated in FIG. 8 can be used to provide the functionality described herein with respect to the edge devices 102 and/or the server computer 114.

The cloud computing platform 800 thus may be utilized to execute any aspects of the software components presented herein. Thus, according to various embodiments of the concepts and technologies disclosed herein, the flexible computation capacity orchestration application 108, the flexible computation capacity orchestration service 112, or the like can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the flexible computation capacity orchestration application 108 and/or the flexible computation capacity orchestration service 112 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that the an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, Calif.; one or more embodiment of the TEGRA brand family of SoCs, available from NVIDIA of Santa Clara, Calif.; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, Calif., and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the flexible computation capacity orchestration application 108, the flexible computation capacity orchestration service 112, and/or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the operational data 110, the flexible computing variables 116, the commands 118, the data for computations 122, the computed data 124, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for flexible computation capacity orchestration have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
obtaining, at a computer, operational data from an edge device, wherein the edge device communicates with the computer via a network, and wherein the operational data comprises utilization data that defines a resource utilization of the edge device,
determining if the resource utilization of the edge device satisfies an upper utilization limit,
if a determination is made that the resource utilization of the edge device satisfies the upper utilization limit, issuing a command to create a device group that comprises the edge device and a further edge device,
obtaining, from the edge device and the further edge device, further operational data that defines a further utilization of the edge device and a utilization of the further edge device,
determining if the further utilization is below a lower utilization limit, and
if a determination is made that the further utilization is below the lower utilization limit, issuing a further command to end the device group.

2. The system of claim 1, wherein the resource utilization of the edge device comprises a processor utilization of the edge device.

3. The system of claim 1, wherein the resource utilization of the edge device satisfies the upper utilization limit by exceeding the upper utilization limit.

4. The system of claim 1, wherein the computer-executable instructions, when executed by the processor, cause the processor to perform operations further comprising:
identifying a pool of candidate edge devices for the device group; and
if a determination is made that a candidate edge device should be added to the device group, instructing the candidate edge device to be added to the device group.

5. The system of claim 4, wherein the determination is made that the candidate edge device should be added to the device group by determining a security requirement for the device group and determining, based on the operational data, that the candidate edge device can satisfy the security requirement.

6. The system of claim 4, wherein identifying the pool of candidate edge devices comprises obtaining opt-ins from the pool of candidate edge devices.

7. The system of claim 4, wherein the computer-executable instructions, when executed by the processor, cause the processor to perform operations further comprising:
if a determination is made that the candidate edge device should not be added to the device group, removing the candidate edge device from the pool of candidate edge devices, wherein the determination is made that the candidate edge device should not be added to the device group based on another utilization of the candidate edge device.

8. The system of claim 4, wherein the computer-executable instructions, when executed by the processor, cause the processor to perform operations further comprising:
if a determination is made that the candidate edge device should not be added to the device group, removing the candidate edge device from the pool of candidate edge devices, wherein the determination is made that the candidate edge device should not be added to the device group based on a security capability of the candidate edge device.

9. A method comprising:
obtaining, at a computer comprising a processor, operational data from an edge device, wherein the edge device communicates with the computer via a network, and wherein the operational data comprises utilization data that defines a resource utilization of the edge device;
determining, by the processor, if the resource utilization of the edge device satisfies an upper utilization limit;
if a determination is made that the resource utilization of the edge device satisfies the upper utilization limit, issuing, by the processor, a command to create a device group that comprises the edge device and a further edge device;
obtaining, by the processor and from the edge device and the further edge device, further operational data that defines a further utilization of the edge device and a utilization of the further edge device;
determining, by the processor, if the further utilization is below a lower utilization limit; and
if a determination is made that the further utilization is below the lower utilization limit, issuing, by the processor, a further command to end the device group.

10. The method of claim 9, further comprising:
identifying a pool of candidate edge devices for the device group; and
if a determination is made that a candidate edge device should be added to the device group, instructing the candidate edge device to be added to the device group.

11. The method of claim 10, wherein the determination is made that the candidate edge device should be added to the device group by determining a security requirement for the device group and determining, based on the operational data, that the candidate edge device can satisfy the security requirement.

12. The method of claim 10, wherein identifying the pool of candidate edge devices comprises obtaining opt-ins from the pool of candidate edge devices.

13. The method of claim 10, further comprising:
if a determination is made that the candidate edge device should not be added to the device group, removing the candidate edge device from the pool of candidate edge devices, wherein the determination is made that the candidate edge device should not be added to the device group based on another utilization of the candidate edge device.

14. A computer storage medium having computer-executable instructions stored thereon that, when executed by a processor, cause the processor to perform operations comprising:
obtaining, at a computer, operational data from an edge device, wherein the edge device communicates with the computer via a network, and wherein the operational data comprises utilization data that defines a resource utilization of the edge device;
determining if the resource utilization of the edge device satisfies an upper utilization limit;
if a determination is made that the resource utilization of the edge device satisfies the upper utilization limit, issuing a command to create a device group that comprises the edge device and a further edge device;
obtaining, from the edge device and the further edge device, further operational data that defines a further utilization of the edge device and a utilization of the further edge device;
determining if the further utilization is below a lower utilization limit; and
if a determination is made that the further utilization is below the lower utilization limit, issuing a further command to end the device group.

15. The computer storage medium of claim 14, wherein the resource utilization of the edge device comprises a processor utilization of the edge device.

16. The computer storage medium of claim 14, wherein the resource utilization of the edge device satisfies the upper utilization limit by exceeding the upper utilization limit.

17. The computer storage medium of claim 14, wherein the computer-executable instructions, when executed by the processor, cause the processor to perform operations further comprising:
identifying a pool of candidate edge devices for the device group; and
if a determination is made that a candidate edge device should be added to the device group, instructing the candidate edge device to be added to the device group.

18. The computer storage medium of claim 17, wherein the determination is made that the candidate edge device should be added to the device group by determining a security requirement for the device group and determining, based on the operational data, that the candidate edge device can satisfy the security requirement.

19. The computer storage medium of claim 17, wherein identifying the pool of candidate edge devices comprises obtaining opt-ins from the pool of candidate edge devices.

20. The computer storage medium of claim 17, wherein the computer-executable instructions, when executed by the processor, cause the processor to perform operations further comprising:
if a determination is made that the candidate edge device should not be added to the device group, removing the candidate edge device from the pool of candidate edge devices, wherein the determination is made that the candidate edge device should not be added to the device group based on another utilization of the candidate edge device.
